(19) United States
(12) Patent Application Publication
(10) Pub. No.: US 2025/0310851 A1
(43) Pub. Date: Oct. 2, 2025

(54) NETWORK GAP DETECTION

(71) Applicant: Cisco Technology, Inc., San Jose, CA (US)

(72) Inventors: Jerome Henry, Pittsboro, NC (US); Sudhir K. Jain, Fremont, CA (US); Venkat Chirreddy, Milpitas, CA (US)

(73) Assignee: Cisco Technology, Inc., San Jose, CA (US)

(21) Appl. No.: 18/620,804

(22) Filed: Mar. 28, 2024

Related U.S. Application Data
(60) Provisional application No. 63/492,960, filed on Mar. 29, 2023.

(51) Int. Cl. H04W 36/32; H04W 36/00; H04W 48/20

(52) U.S. Cl. CPC H04W 36/322; H04W 36/0058; H04W 36/00835; H04W 48/20

(57) ABSTRACT

Network coverage issue detection and, particularly, enabling a client device to detect and report network coverage issues including gaps may be provided. Detecting coverage issues can include associating to a first Access Point (AP) and exchanging a low coverage threshold with the first AP. A new AP is determined to roam to based on the low coverage threshold. In response, neighbor report is requested and received from the first AP. AP discovery signaling is performed, comprising scanning neighbor APs using the neighbor report, and selecting a second AP to roam to. The second AP is associated to, and low coverage information is sent to the second AP comprising information associated with the determination to roam to the new AP based on the low coverage threshold.

### RELATED APPLICATION

Under provisions of 35 U.S.C. § 119(e), Applicant claims benefit of U.S. Provisional Application No. 63/492,960, filed Mar. 29, 2023, which is incorporated herein by reference.

### TECHNICAL FIELD

The present disclosure relates generally to network coverage issue detection and, particularly, to enabling a client device to detect and report network coverage issues including gaps.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment;

FIG. 2 is a block diagram of a signal process for network coverage issue detection;

FIG. 3 is a block diagram of an example AP deployment;

FIG. 4 is a flow chart of a method for network coverage issue detection; and

FIG. 5 is a block diagram of a computing device.

### DETAILED DESCRIPTION

### Overview

Network coverage issue detection and, particularly, enabling a client device to detect and report network coverage issues including gaps may be provided. Detecting coverage issues can include associating to a first Access Point (AP) and exchanging a low coverage threshold with the first AP. A new AP is determined to roam to based on the low coverage threshold. In response, neighbor report is requested and received from the first AP. AP discovery signaling is performed, comprising scanning neighbor APs using the neighbor report, and selecting a second AP to roam to. The second AP is associated to, and low coverage information is sent to the second AP comprising information associated with the determination to roam to the new AP based on the low coverage threshold.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Wireless network providers deploy systems (e.g., Wi-Fi deployments) to enable clients (e.g., a Station (STA)) to connect to network services such as the Internet. To provide coverage at intended areas without gaps, deployment techniques may utilize assumed cell sizes that a device, such as an Access Point (AP), will provide and may include positioning the devices to have overlap areas between the cells. Once the network is deployed, AP-to-AP communication (e.g. Null Data Packet (NDP) messages) can help the network providers to evaluate the proximity of neighboring APs and deduce the likely signal level of clients between these APs. Based on this data, the network provider can utilize AP management techniques such as Radio Resource Management (RRM) to manage radio resources and other radio transmission characteristics to dynamically increase or reduce AP power to attempt to provide the best possible or otherwise sufficient coverage overlap between APs.

Data from the APs used to manage AP power may provide an inaccurate indication of the actual coverage of the APs because APs may be positioned in areas where a client device will not typically be positioned. For a network deployment in a building for example, APs may be positioned on ceilings while client devices will typically be positioned on the floors of the building. The network coverage may appear to be sufficient and without gaps based on data from communications between APs positioned on the ceilings of the building, but the coverage may be insufficient on the floors of the building. For example, there may be obstacles that do not exist between APs on the ceiling but do exist to interrupt coverage to the floor where clients are located. Thus, the AP-to-AP communications may be insufficient for a network provider to determine a gap in coverage that a client device may be positioned in.

Additionally, client device may have different form factors and Radio Frequency (RF) characteristics than the form factors and RF characteristics of the APs. The APs may be able to communicate to their neighbor APs, but this may not indicate sufficient coverage because a client device with a different form factor and different RF characteristics may have different communications capabilities. Thus, a client device with a different form factor and/or different RF characteristics may be unable to communicate with any APs in certain areas of the intended coverage that AP-to-AP communications indicate are covered, such as at overlap areas between APs. The data acquired solely from AP-to-AP communications is therefore insufficient to ensure proper network coverage for client devices. Methods are described herein for client devices to provide additional data for a network provider to determine the network coverage the APs and/or other network devices are providing. For example, the client devices may provide information associated with the quality of the links to each AP (e.g., when the connection quality degrades below one or more thresholds) for the network provider to determine the quality of coverage, identify gaps in coverage, and/or the like.

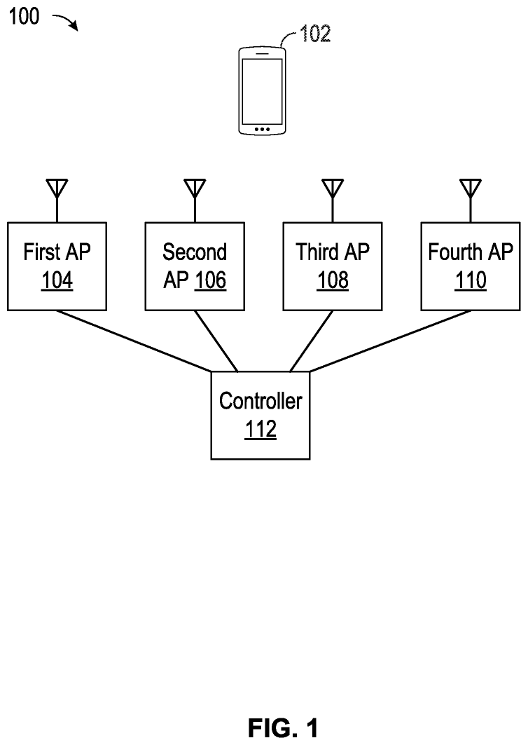

FIG. 1 is a block diagram of an operating environment 100. The operating environment 100 may include a client 102, a first AP 104, a second AP 106, a third AP 108, a fourth AP 110, and a controller 112. The client 102 may be any client device (e.g., a STA) that connects to the network to communicate with other devices on the network, such as a smart phone, a tablet, a personal computer, a server, and/or the like. The controller 112 may be any network controller (e.g., a Wireless Local Area Network (WLAN) controller) and may manage the first AP 104, the second AP 106, the third AP 108, the fourth AP 110, and/or other network devices to allow wireless devices such as the client 102 to connect to the network. In some examples, the first AP 104, the second AP 106, the third AP 108, and the fourth AP 110 may connect directly to the network or connect through a gateway device not shown. In some embodiments, the operations of the controller 112 described herein may be performed by one or more of the first AP 104, the second AP 106, the third AP 108, the fourth AP 110, and/or another device, and vice versa. The first AP 104, the second AP 106, the third AP 108, and the fourth AP 110 have a wired connection to the controller 112 in this example but may wirelessly connect to the controller 112 in other examples. The operating environment 100 is an example configuration and there may be a different number of clients, APs, controllers, and/or other devices in further examples.

The first AP 104, the second AP 106, the third AP 108, and the fourth AP 110 may be positioned to provide coverage over an intended coverage area. A network provider may determine positions and determine operating characteristics (e.g., AP power) for the first AP 104, the second AP 106, the third AP 108, and the fourth AP 110 to provide the best signal strength possible and provide the best performance in the coverage area. However, as described above, determining the placement and AP operating characteristics may require data associated with the performance of the first AP 104, the second AP 106, the third AP 108, and the fourth AP 110 in their determined positions. The network provider may collect data associated with the network performance based on AP-to-AP communications between the first AP 104, the second AP 106, the third AP 108, and the fourth AP 110, but this data from the AP-to-AP communications alone may not be sufficient to identify coverage issues for clients, such as the client 102.

To detect coverage issues, the client 102 may create coverage reports or otherwise collect data associated with the network coverage the client 102 experiences for transmission to the first AP 104, the second AP 106, the third AP 108, the fourth AP 110, and/or the controller 112. The first AP 104, the second AP 106, the third AP 108, the fourth AP 110, and/or controller 112 may process the data the client 102 transmits to detect coverage issues and determine how to adjust the operation of network devices, add additional network devices, and/or adjust the position of network devices to remedy the coverage issues (e.g., gaps in coverage). For example, the controller 112 can adjust AP characteristics of one or more of the first AP 104, the second AP 106, the third AP 108, and the fourth AP 110 to remedy the coverage issues. In some examples, the controller 112 may determine that the coverage issues cannot be remedied by adjusting AP characteristics or the changes will cause other network issues such as interference, new network coverage issues, and/or the like. Thus, the controller 112 may log or otherwise flag that the determined network coverage issues cannot be remedied by adjusting operating characteristics alone, and the network provider may be alerted to install a new AP or adjust the positions of one or more of the first AP 104, the second AP 106, the third AP 108, and the fourth AP 110.

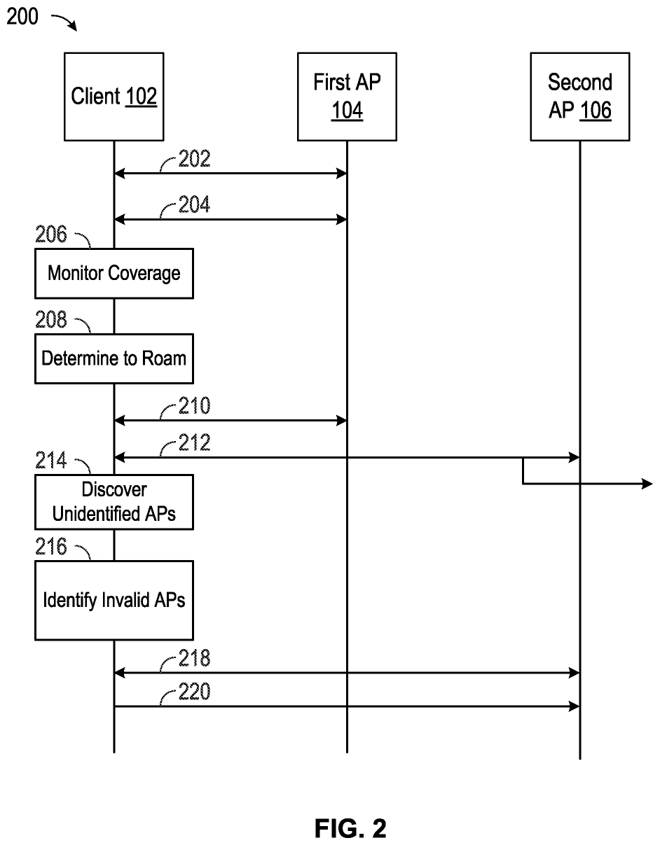

FIG. 2 is a block diagram of a signal process 200 for network coverage issue detection. The signal process 200 may illustrate an example process for the client 102 to detect coverage issues and report the issues to network devices (e.g., the first AP 104, the second AP 106, the third AP 108, the fourth AP 110, the controller 112, etc.). The network devices may then adjust operation to remedy the coverage issues and/or log or otherwise report the coverage issues so a network provider can remedy the coverage issues.

The client 102 may initially associate to one of the first AP 104, the second AP 106, the third AP 108, or the fourth AP 110 to connect to the network. For example, the client 102 may be positioned so the first AP 104 provides the best network connection, so the client 102 may determine to associate with the first AP 104. Thus, the signal process 200 begins with the association signaling 202, and the association signaling 202 can include any signals and operations for the client 102 to associate to the first AP 104. For example, the client 102 and the first AP 104 may exchange a probe request, a probe response, an authentication request, an authentication response, and/or the like so the client 102 associates with the first AP 104. Once the client 102 has associated with the first AP 104, the client 102 can access the network and exchange signals with the first AP 104.

After the association signaling 202, the client 102 and the first AP 104 can exchange or otherwise establish a low coverage threshold value via low coverage initialization signaling 204. The coverage threshold may be a value the client 102 uses to determine that the coverage (e.g., signals from the first AP 104) is below acceptable performance. The coverage threshold value may be a Received Signal Strength Indicator (RSSI) threshold and/or a Signal to Noise Ratio (SNR) threshold.

In some embodiments, the low coverage initialization signaling 204 includes the first AP 104 requesting the coverage threshold from the client 102 in an action frame and the client 102 replying with the coverage threshold. In other embodiments, the low coverage initialization signaling 204 includes the client 102 sending a coverage threshold request to the first AP 104 (e.g., via a robust action frame). The first AP 104 may respond with the coverage threshold (e.g., via an action frame). The first AP 104 may therefore configure the client 102 to use the desired coverage threshold value, for example because the coverage threshold may be determined based on network characteristics such as the AP density. In yet other embodiments, the low coverage initialization signaling 204 may include the client 102 sending to the first AP 104 a preset or predetermined coverage threshold (e.g. the threshold is always a −75 dBm RSSI threshold). In some examples, the client 102 may not share the preset value with the first AP 104 because the first AP 104 may only require the client 102 to notify the first AP 104 when the coverage is lower than the preset coverage threshold. Thus, the low coverage initialization signaling 204 may not be performed in some examples. The low coverage initialization signaling 204 (i.e., the exchange of the low coverage threshold between the client 102 and the first AP 104) therefore may include the client 102 establishing the coverage threshold, the connected AP (i.e., the first AP 104 in this example) or the controller 112 establishing the coverage threshold, or the client 102 sharing a preset coverage threshold automatically without a request from the first AP 104.

In addition to establishing the coverage threshold, the low coverage initialization signaling 204 may include the client 102 and the first AP 104 exchanging one or more low coverage Key Performance Indicators (KPIs). The low coverage KPIs can include a low coverage period that sets a duration (e.g., a time value such as ten seconds) for the coverage to be below the coverage threshold before the client 102 considers the coverage to have a gap and/or other issue. In some examples, the low coverage period may define when the client 102 should perform a low coverage evaluation (e.g. perform one evaluation per packet the client 102 receives from the first AP 104, perform one evaluation of one packet per second). The low coverage KPIs can also or alternatively include a low coverage percentage that sets a percentage of sampled packets that have coverage below the coverage threshold before the client 102 determines there are one or more coverage issues. The low coverage KPIs can also or alternatively include a packet quantity that sets a quantity of missed packets before the client 102 determines there are one or more coverage issues.

After the low coverage initialization signaling 204, the client 102 may monitor the network coverage in operation 206. The client 102 may monitor the network coverage to identify and/or store information associated with coverage issues, such as coverage gaps. The client 102 may continue to monitor the network coverage for the duration of the signal process 200 and after the signal process 200 (e.g., as long as the client 102 is connected to the network). The monitoring may be a passive action by the client 102 or otherwise performed by the client 102 during normal operation. For example, the monitoring may simply be logging information associated with communications that the client 102 performs with the first AP 104 to access the network for any reason. Therefore, the client 102 may not need to perform any new operations to monitor the network coverage in operation 206.

In some embodiments, the client 102 may determine there is low coverage when the client 102 stops properly receiving beacons from the first AP 104. The client 102 may use the low coverage period as the time to not receive beacons to determine there is a gap and/or other issue. For example, the low coverage period may be five seconds, so the client 102 may determine there is a gap and/or other issue when the client 102 does not receive beacons from the first AP 104 for five seconds. Alternatively or additionally, the client 102 may use the low coverage percentage or a quantity of beacons before determining there is a gap and/or other issue. For example, the client 102 may determine there is a gap and/or other issue when the client 102 does not receive a beacon from the first AP 104 for twenty consecutive beacons or the client 102 does not receive beacons from the first AP 104 for the percentage of consecutive beacons set by the low coverage percentage.

When the client 102 moves away from the first AP 104 and is nearing or reaches the edge of the first AP 104 range, the client 102 may determine to roam in operation 208. For example, the client 102 determines to roam based on the low coverage threshold. The client 102 may then initiate roaming via roaming assistance signaling 210 and AP discovery signaling 212 to discover neighboring APs (e.g., the second AP 106, the third AP 108, the fourth AP 110) to roam to. The roaming assistance signaling 210 can include the client 102 requesting from the first AP 104 a neighbor report (e.g., as described by the Institute of Electrical and Electronics Engineers (IEEE) 802.11k amendment) for use when discovering neighboring APs. The first AP 104 and/or the controller 112 may generate the neighbor report including a list of candidate APs for the client 102 to roam to. For example, the first AP 104 and/or the controller 112 may identify the second AP 106, the third AP 108, and/or the fourth AP 110 as candidate APs for inclusion in the neighbor report. The first AP 104 may then transmit the neighbor report to the client 102. The roaming assistance signaling 210 can also include the first AP 104 transmitting to the client 102 a recommendation of which candidate AP to roam to (e.g., via a Basic Service Set (BSS) Transition Management frame as described by the IEEE 802.11v amendment).

After the roaming assistance signaling 210, the client 102 can initiate the AP discovery signaling 212. The AP discovery signaling 212 can include the client 102 passively or actively scanning to identify APs and select an AP to roam to. The client 102 may scan the matching channels of the first AP 104 and/or the matching channels indicated in the neighbor report. When passively scanning, the client 102 may receive beacon frames from APs, such as the second AP 106. When actively scanning, the client 102 may send a probe request to neighbor APs (i.e., the second AP 106) and receive a probe response from the neighbor APs.

In operation 214, the client 102 may discover unidentified APs (i.e., APs that the first AP 104 did not identify). The client 102 may perform operation 214 during the AP discovery signaling 212 in some examples. The unidentified APs may be advertising the same Service Set Identifier (SSID) as the first AP 104 that the first AP 104 did not include in the neighbor report or recommendation. The unidentified APs may be valid infrastructure APs or rogue APs. The client 102 may store information associated with the unidentified APs, such as identifiers (e.g., BSSID), operating characteristics (e.g., channel), and the like, for transmission to the first AP 104, the controller 112, and/or another network device.

In operation 216, the client 102 may also identify invalid APs. The client 102 may perform operation 216 during the AP discovery signaling 212 in some examples. Invalid APs can include APs that advertise invalid parameters. The invalid parameters can include invalid Information Elements (IEs), contradicting parameters, unknown options in a known IE, invalid options in a known IE. In some embodiments, the client 102 may use AP beacons or probe responses to identify invalid APs. Additionally, the client 102 may attempt to associate with one or more APs and fail, such as failing to associate during authentication, association, or other actions such as the handshake. The client 102 may store information associated with the invalid APs, such as identifiers (e.g., the BSS Identifier (BSSID)), operating characteristics, the invalid parameters, failed association attempt information, and the like, for transmission to the first AP 104, the controller 112, and/or another network device. In some examples, the client 102 may transmit invalid AP information to the first AP 104 during the association signaling 202, such as when the client 102 fails to associate with one or more other APs before the association signaling 202 or the client identifies invalid APs during the association signaling 202.

Once the client 102 selects an AP to roam to, the client 102 may associate to the selected AP. For example, the client 102 may determine the second AP 106 is the best or otherwise preferred AP to roam to and associate to the second AP 106 via the reassociation signaling 218. The reassociation signaling 218 between the client 102 and the second AP 106 may include any signals and operations for association (e.g., a probe request, a probe response, an authentication request, an authentication response, etc.).

After the reassociation to the second AP 106, the client 102 may send one or more low coverage information signals 220 to the second AP 106. The one or more low coverage information signals 220 may include information associated with coverage issues and/or AP discovery issues, including information associated with a determination to roam to a new AP based on the low coverage threshold, information associated with identified coverage issues, information associated with the unidentified APs, and/or information associated with the invalid APs for example. The client 102 may transmit the one or more low coverage information signals 220 to the second AP 106 via a series of Protected Management Frames (PMFs). The PMFs may be vendor (e.g., network provider and/or device provider) specific action frames.

In some embodiments, the client 102 may additionally or alternatively transmit the one or more low coverage information signals 220 to the first AP 104 (e.g., before reassociation or after reassociation and within range of the first AP 104). For example, the client 102 may transmit the one or more low coverage information signals 220 to the first AP 104 when low coverage threshold and/or the low coverage period is reached, when the client 102 resumes receiving beacons from the first AP 104 after the percentage of missed beacons set by the low coverage percentage is reached and/or the low coverage period without a received beacon occurs, in response to identifying unidentified APs and/or APs advertising invalid parameters during AP discovery signaling 212, and/or the like. The first AP 104 may be able to receive the one or more low coverage information signals 220 properly even if the coverage is low from the viewpoint of the client 102, during the reassociation process, and/or the like.

In some examples, the one or more low coverage information signals 220 may comprise a single action frame with multiple IEs the client 102 can use to send the information associated with coverage issues, AP discovery issues, and/or the like. For example, the action frame may include a low coverage IE, a missed beacons IE, an invalid APs IE, an unidentified APs IE, a roaming reason IE, and/or the like. The client 102 may use the low coverage IE (e.g., a low RSSI IE and/or low SNR IE) to indicate the one or more durations and/or one or more positions of the client 102 for which the client 102 was below the low coverage threshold (e.g., the low RSSI threshold and/or the low SNR threshold) when connected to the first AP 104 before determining to roam to the second AP 106. The client 102 may use the missed beacons IE indicate the number and/or duration of missed beacons before the client 102 determined to roam to the second AP 106. The client 102 may use the invalid APs IE to send the information associated with the invalid APs (e.g., identifiers, operating characteristics, the invalid parameters, failed association attempt information, and the like) that the client 102 detected in operation 214 (e.g., during the AP discover signaling 212). The client 102 may use the unidentified APs IE to indicate information associated with the unidentified APs (e.g., identifier, operating characteristics, etc.).

The client 102 may use the roaming reason IE to indicate the reasons the client 102 selected the second AP 106 to roam to. For example the roaming reason IE may include a code that represents the reason why the client 102 selected the second AP 106 (e.g., a code indicating best RSSI, a code indicating best channel availability (i.e., low load), etc.). The client 102 may select the second AP 106 for multiple reasons, and the code may indicate the rankings for the multiple reasons, such as the second AP 106 has the second best RSSI −65 dBm and the best channel availability at twenty percent utilization. The second AP 106 can use the information in the roaming reason IE to estimate the roaming decision parameters of the client 102. The roaming decision IE can also include the reasons the client 102 determined to roam (e.g. first AP 104 RSSI too low, Modulation and Coding Scheme (MCS) decline slope too stiff, not receiving beacons from the first AP 104, etc.).

The second AP 106 may process the data the client 102 transmits in the one or more low coverage information signals 220 to detect coverage issues and determine how to adjust the operation of network devices, add additional network devices, and/or adjust the position of network devices to remedy the coverage issues. In some embodiments, the second AP 106 may transmit the one or more low coverage information signals 220 the controller 112, and the controller 112 may detect coverage issues and determine how to adjust the operation of network devices, add additional network devices, and/or adjust the position of network devices to remedy the coverage issues. For example, the controller 112 can adjust AP characteristics of one or more of the first AP 104, the second AP 106, the third AP 108, and the fourth AP 110 to remedy the coverage issues. In some examples, the controller 112 may determine that the coverage issues cannot be remedied by adjusting AP characteristics or the changes will cause other network issues such as interference, new network coverage issues, and/or the like. Thus, the controller 112 may log or otherwise flag that the determined network coverage issues cannot be remedied by adjusting operating characteristics alone, and the network provider may be alerted to install a new AP or adjust the positions of one or more of the first AP 104, the second AP 106, the third AP 108, and the fourth AP 110.

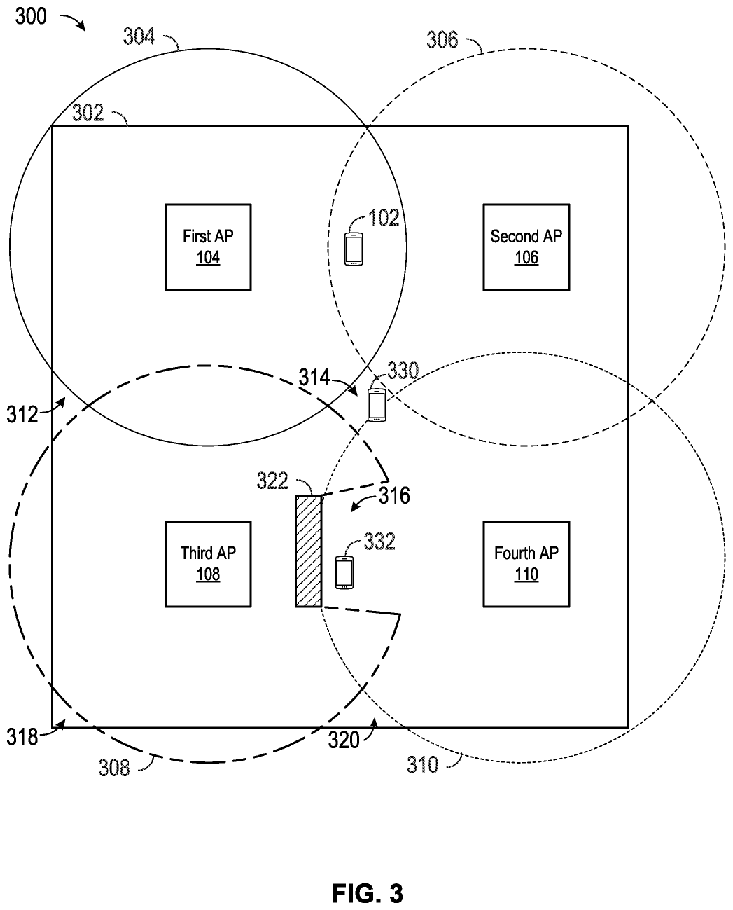

FIG. 3 is a block diagram of an example AP deployment 300. The AP deployment 300 may include the first AP 104, the second AP 106, the third AP 108, and the fourth AP 110 positioned in a coverage area 302. The first AP range 304 illustrates the assumed range of the first AP 104, the second AP range 306 illustrates the assumed range of the second AP 106, the third AP range 308 illustrates the assumed range of the third AP 108, and the fourth AP range 310 illustrates the assumed range of the fourth AP 110. The AP ranges assumed, such as via AP-to-AP communication, and the first AP 104, the second AP 106, the third AP 108, and the fourth AP 110 may have practical ranges that do not match the assumed ranges and coverage issues (e.g., gaps not illustrated in FIG. 3) based on position, obstacles, AP characteristics, and/or the like in other examples.

Additionally, the coverage area 302 may have a first coverage gap 312, a second coverage gap 314, a third coverage gap 316, a fourth coverage gap 318, and a fifth coverage gap 320. The first coverage gap 312, the second coverage gap 314, the third coverage gap 316, the fourth coverage gap 318, and the fifth coverage gap 320 may be gaps in coverage the first AP 104, the second AP 106, the third AP 108, and the fourth AP 110 provide and may be caused by AP operating characteristics, AP range limits, obstacles, and/or the like. For example, the obstruction 322 may cause the third coverage gap 316 for the third AP range 308, and insufficient overlap between the first AP 104, the third AP 108, and the fourth AP 110 may cause the first coverage gap 312, the second coverage gap 314, the fourth coverage gap 318, and the fifth coverage gap 320.

For the reasons described above, AP-to-AP communications between the first AP 104, the second AP 106, the third AP 108, and the fourth AP 110 may be insufficient for the controller 112, the first AP 104, the second AP 106, the third AP 108, the fourth AP 110, and/or some other network device to identify the first coverage gap 312, the second coverage gap 314, the third coverage gap 316, the fourth coverage gap 318, the fifth coverage gap 320, and the practical ranges that do not match the assumed ranges and coverage issues (e.g., gaps not illustrated in FIG. 3) based on position, obstacles, AP characteristics, and/or the like. Therefore, the client 102, a second client 330, and/or a third client 332 can perform the operations described above, such as the signaling and operations described in the signal process 200, to report information associated with coverage issues.

The client 102 may be associated to the first AP 104 as described in the signal process 200. The client 102 is posited near the edge of the first AP range 304 and may determine to roam to a new AP (e.g., operation 208). The client 102 may determine to roam to the second AP 106 and send the low coverage information to the first AP 104 and/or the second AP 106 as described in the signal process 200. For example, the first AP 104 may provide insufficient coverage at the near the edge of the first AP range 304 where the client 102 is located.

The second client 330 may be associated with the first AP 104 and be currently positioned in the second coverage gap 314. Therefore, the first AP 104 is not providing coverage to the second client 330, and the second client 330 will determine to roam. For example, the second client 330 may select and roam to the fourth AP 110. The second client 330 may then share low coverage information, including the presence of the second coverage gap 314, with the fourth AP 110.

The third client 332 may be associated with the third AP 108 and be positioned in the third coverage gap 316. Therefore, because the obstruction 322 is blocking the third AP 108 from communicating with the third client 332, the third client 332 may determine to roam. The third client 332 may select and roam to the fourth AP 110. the third client 332 may then share low coverage information, including the presence of the third coverage gap 316, with the fourth AP 110. The first AP 104, the second AP 106, the third AP 108, the fourth AP 110, and/or the controller 112 may use the low coverage information received from the client 102, the second client 330, and the third client 332 to remedy the coverage issues the low coverage information identifies by adjusting operation and/or reporting the coverage issues to a network provider.

While no client devices are positioned in the first coverage gap 312, the fourth coverage gap 318, or the fifth coverage gap 320, the first coverage gap 312, the fourth coverage gap 318, and the fifth coverage gap 320 may be later identified when client devices do move into those positions. If no clients move into those positions for identifying the gaps, there may be no need to remedy the coverage issues. For example, there may be an obstacle that covers the entire fifth coverage gap 320, and no client device will ever be positioned in the fifth coverage gap 320.

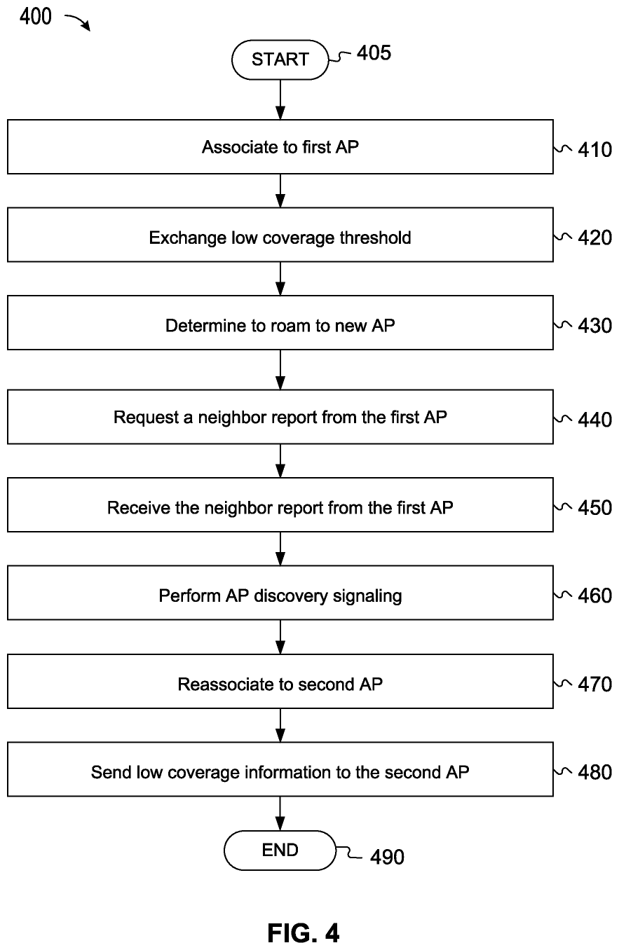

FIG. 4 is a flow chart of a method 400 for network coverage issue detection. The method 400 may begin at starting block 405 and proceed to operation 410. In operation 410, a first AP may be associated to. For example, the client 102 associates to the first AP 104. In operation 420, a low coverage threshold is exchanged with the first AP. For example, the client 102 exchanges the low coverage threshold with the first AP 104. The exchange can comprise any of the operations described above, such as the client 102 requesting the low coverage threshold from the first AP 104, the client sending the low coverage threshold to the first AP, and the like. The client 102 and the first AP 104 may additionally exchange low coverage KPIs as described above.

In operation 430, it is determined to roam to a new AP based on the low coverage threshold. For example, the client 102 determines to roam to a new AP based on the low coverage threshold. The client 102 may also determine to roam to a new AP based on the low coverage KPIs.

In operation 440, a neighbor report is requested, by the client 102 for example, from the first AP 104. In operation 450, the neighbor report is received, by the client for example, from the first AP 104. In operation 460, AP discovery signaling is performed. For example, the client 102 performs the AP discovery signaling, including scanning neighbor APs using the neighbor report, and selecting the second AP 106 to roam to. The AP discovery signaling can also include the client 102 identifying invalid APs and/or unidentified APs.

In operation 470, the second AP is associated to. For example, the client 102 associates to the second AP 106. In operation 480, low coverage information is sent to the second AP. For example, the client 102 sends the low coverage information to the second AP 106. The low coverage information can include information associated with the determination to roam to the new AP based on the low coverage threshold. The low coverage information can also include information associated with any invalid APs and/or information associated with any unidentified APs. As described above, the low coverage information can include a low coverage information IE, a missed beacon IE, an invalid APs IE, an unidentified APs IE, and/or a roaming session IE. In some embodiments, the client 102 can send the low coverage information to the first AP 104 (i.e., the AP the client 102 was previously associated to). The method 400 may conclude at ending block 490.

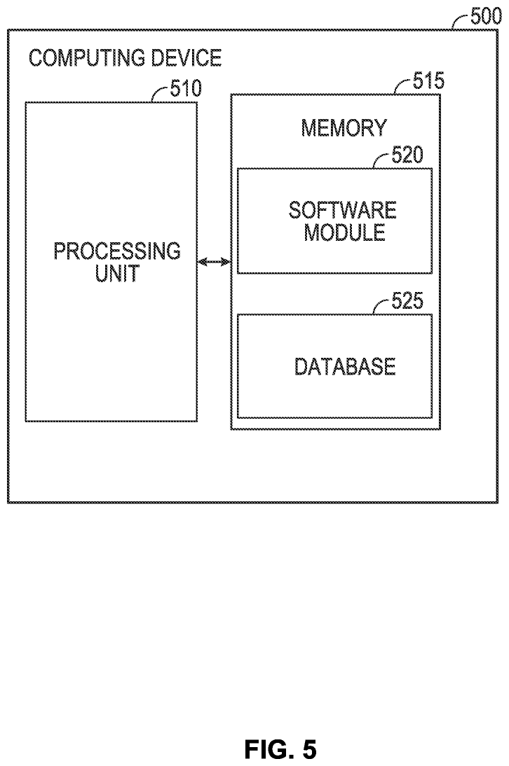

FIG. 5 is a block diagram of a computing device 500. As shown in FIG. 5, computing device 500 may include a processing unit 510 and a memory unit 515. Memory unit 515 may include a software module 520 and a database 525. While executing on processing unit 510, software module 520 may perform, for example, processes for network coverage issue detection with respect to FIG. 1, FIG. 2, and FIG. 3. Computing device 500, for example, may provide an operating environment for the client 102, the first AP 104, the second AP 106, the third AP 108, the fourth AP 110, the controller 112, the second client 330, the third client 332, and the like. The client 102, the first AP 104, the second AP 106, the third AP 108, the fourth AP 110, the controller 112, the second client 330, the third client 332, and the like may operate in other environments and are not limited to computing device 500.

Computing device 500 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 500 may comprise any computer operating environment, such as hand-held devices, multiprocessor systems, microprocessor-based or programmable sender electronic devices, minicomputers, mainframe computers, and the like. Computing device 500 may also be practiced in distributed computing environments where tasks are performed by remote processing devices. The aforementioned systems and devices are examples, and computing device 500 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 500 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
associating to a first Access Point (AP);
exchanging a low coverage threshold with the first AP;
determining to roam to a new AP based on the low coverage threshold; and
in response to determining to roam to the new AP:
requesting a neighbor report from the first AP,
receiving the neighbor report from the first AP,
performing AP discovery signaling, comprising:
scanning neighbor APs using the neighbor report, and
selecting a second AP to roam to,
associating to the second AP, and
sending low coverage information to the second AP, the low coverage information comprising information associated with the determination to roam to the new AP based on the low coverage threshold.

2. The method of claim 1, further comprising sending the low coverage information to the first AP.

3. The method of claim 1, further comprising exchanging one or more low coverage Key Performance Indicators (KPIs), wherein the one or more low coverage KPIs comprise any one of: (i) a low coverage period, (ii) a low coverage percentage, (iii) a packet quantity, or (iv) any combination of (i)-(iii).

4. The method of claim 3, wherein determining to roam to the new AP is further based on the one or more low coverage KPIs.

5. The method of claim 1, wherein:
performing the AP discovery signaling further comprises identifying any one of (i) an unidentified AP, (ii) an invalid AP, or (iii) both (i) and (ii); and
the low coverage information includes any one of (iv) information associated with the unidentified AP, (v) information associated with the invalid AP, or (vi) both (iv) and (v).

6. The method of claim 1, further comprising identifying a coverage issue based on the low coverage threshold, wherein the low coverage information further comprises information associated with the coverage issue.

7. The method of claim 1, wherein the low coverage information comprises any one of:
(i) a low coverage Information Element (IE) indicating a duration of low coverage before determining to roam to the new AP,
(ii) a missed beacon IE indicating a number of missed beacons before determining to roam to the new AP,
(iii) an invalid APs IE comprising information associated with one or more invalid APs,
(iv) an unidentified APs IE comprising information associated with one or more unidentified APs,
(v) a roaming session IE indicating one or more reasons the second AP was selected to roam to, or
(vi) any combination of (i)-(v).

8. The method of claim 1, wherein the low coverage threshold is any one of (i) a Received Signal Strength Indicator (RSSI) threshold, (ii) a Signal to Noise Ratio (SNR) threshold, or (iii) a combination of (i) and (ii).

9. A system comprising:
a memory storage; and
a processing unit coupled to the memory storage, wherein the processing unit is operative to:
associate to a first Access Point (AP);
exchange a low coverage threshold with the first AP;
determine to roam to a new AP based on the low coverage threshold; and
in response to the determination to roam to the new AP:
request a neighbor report from the first AP,
receive the neighbor report from the first AP,
perform AP discovery signaling, comprising to:
scan neighbor APs using the neighbor report, and
select a second AP to roam to,
associate to the second AP, and
send low coverage information to the second AP, the low coverage information comprising information associated with the determination to roam to the new AP based on the low coverage threshold.

10. The system of claim 9, wherein the processing unit is further operative to send the low coverage information to the first AP.

11. The system of claim 9, wherein:
the processing unit is further operative to exchange one or more low coverage Key Performance Indicators (KPIs), wherein the one or more low coverage KPIs comprise any one of: (i) a low coverage period, (ii) a low coverage percentage, (iii) a packet quantity, or (iv) any combination of (i)-(iii); and
to determine to roam to the new AP is further based on the one or more low coverage KPIs.

12. The system of claim 9, wherein:
to perform the AP discovery signaling further comprises to identify any one of (i) an unidentified AP, (ii) an invalid AP, or (iii) both (i) and (ii); and
the low coverage information includes any one of (iv) information associated with the unidentified AP, (v) information associated with the invalid AP, or (vi) both (iv) and (v).

13. The system of claim 9, the processing unit is further operative to identify a coverage issue based on the low coverage threshold, wherein the low coverage information further comprises information associated with the coverage issue.

14. The system of claim 9, wherein the low coverage information comprises any one of:
(i) a low coverage Information Element (IE) indicating a duration of low coverage before determining to roam to the new AP,
(ii) a missed beacon IE indicating a number of missed beacons before determining to roam to the new AP,
(iii) an invalid APs IE comprising information associated with one or more invalid APs,
(iv) an unidentified APs IE comprising information associated with one or more unidentified APs,
(v) a roaming session IE indicating one or more reasons the second AP was selected to roam to, or
(vi) any combination of (i)-(v).

15. The system of claim 9, wherein the low coverage threshold is any one of (i) a Received Signal Strength Indicator (RSSI) threshold, (ii) a Signal to Noise Ratio (SNR) threshold, or (iii) a combination of (i) and (ii).

16. A non-transitory computer-readable medium that stores a set of instructions which when executed perform a method executed by the set of instructions comprising:
associating to a first Access Point (AP);
exchanging a low coverage threshold with the first AP;
determining to roam to a new AP based on the low coverage threshold; and
in response to determining to roam to the new AP:
requesting a neighbor report from the first AP,
receiving the neighbor report from the first AP,
performing AP discovery signaling, comprising:
scanning neighbor APs using the neighbor report, and
selecting a second AP to roam to,
associating to the second AP, and
sending low coverage information to the second AP, the low coverage information comprising information associated with the determination to roam to the new AP based on the low coverage threshold.

17. The non-transitory computer-readable medium of claim 16, the method executed by the set of instructions further comprising sending the low coverage information to the first AP.

18. The non-transitory computer-readable medium of claim 16, the method executed by the set of instructions further comprising exchanging one or more low coverage Key Performance Indicators (KPIs), wherein the one or more low coverage KPIs comprise any one of: (i) a low coverage period, (ii) a low coverage percentage, (iii) a packet quantity, or (iv) any combination of (i)-(iii), wherein determining to roam to the new AP is further based on the one or more low coverage KPIs.

19. The non-transitory computer-readable medium of claim 16, wherein:
performing the AP discovery signaling further comprises identifying any one of (i) an unidentified AP, (ii) an invalid AP, or (iii) both (i) and (ii); and
the low coverage information includes any one of (iv) information associated with the unidentified AP, (v) information associated with the invalid AP, or (vi) both (iv) and (v).

20. The non-transitory computer-readable medium of claim 16, wherein the low coverage information comprises any one of:
(i) a low coverage Information Element (IE) indicating a duration of low coverage before determining to roam to the new AP,
(ii) a missed beacon IE indicating a number of missed beacons before determining to roam to the new AP,
(iii) an invalid APs IE comprising information associated with one or more invalid APs,
(iv) an unidentified APs IE comprising information associated with one or more unidentified APs,
(v) a roaming session IE indicating one or more reasons the second AP was selected to roam to, or
(vi) any combination of (i)-(v).
